(19) United States
(12) Patent Application Publication
(10) Pub. No.: US 2008/0296407 A1
(43) Pub. Date: Dec. 4, 2008

(54) Spray can assembly for painting golf holes

(76) Inventor: Kurt Schleicher, Irvine, CA (US)

Correspondence Address: RUSSO & DUCKWORTH , LLP, 9090 IRVINE CENTER DRIVE , SECOND FLOOR, IRVINE, CA, 92618, US

(21) Appl. No.: 11/810,408

(22) Filed: Jun. 4, 2007

(51) Int. Cl. A62C 13/62

(52) U.S. Cl. 239/302

(57) ABSTRACT

A spray paint can positioning apparatus is provided for painting the interior of a golf hole. The positioning apparatus includes a planar base having a central opening and a plurality of downwardly extending arms forming a receptacle for holding a spray paint can. Each of the arms engage a circular masking plate having a diameter substantially the same as the diameter of a golf hole. A cup having a circular sidewall is formed on the top of the masking plate for receipt of the push button from an inverted spray paint can. Located in the middle of the cup, a projection is positioned to engage and depress the push button of a spray paint can. The cup is sized to prevent lateral movement of the spray can push button and the masking plate provides a uniform width of paint around the interior periphery of a golf hole.

### BACKGROUND OF THE INVENTION

The present invention relates to the preparation of golf holes on a golf course. More particularly, the present invention relates to devices for creating a white paint to the walls of golf hole for providing greater visibility to golfers.

A golf hole is typically formed in a golf green by removing a cylindrical section of grass and underlying dirt using a specialized hole cutting tool. The cutting tool is positioned in a desired location after which a greenskeeper tries to maintain the cutter perpendicular to the green's surface while forcing the cutter into the ground. The cutter inserts the cutting tool to a desired depth after which the cutting tool is removed, thereby removing a plug of earth and grass and leaving a hole in the green. If a golf hole has previously been formed within the same green, the greenskeeper will typically place the removed plug of earth and grass and place it into the previously formed golf hole. A plastic cup, which may have been removed from the previously existing golf hole, is then inserted into the bottom of the newly formed golf hole.

Many greenskeepers apply white paint to the interior of the golf hole above the cup. There are several methods for painting the interior of the golf hole. These include painting the interior of the golf hole by hand such as a greenskeeper using a paintbrush. This technique is physically difficult and requires a great deal of time to complete the task.

Spray paint cans have been used for applying white paint to the interior of a golf hole. One technique is for the greenskeeper to simply spray paint from the can by manually manipulating the spray can to point the nozzle toward the interior of the golf hole. Unfortunately, this method can result in an uneven spraying of paint, the wasting of paint, and a spraying of paint exterior to the golf hole. An effort to overcome this obstacle is described in U.S. Pat. No. 4,797,305. This reference describes an apparatus for holding and positioning a spray paint can so that the nozzle is centrally aligned with the golf hole's central axis during the painting operation. The apparatus includes a base for resting upon the surface of a golf green and a receptacle which extends downward from the base for receipt of the spray can. The base holds and positions a spray paint can in a desired position so that the nozzle points to the inner sidewall of the golf hole. The apparatus further includes a screw head positioned to engage the spray can nozzle button so as to cause the button's depression and accompanying spray of paint. In operation, a spray can is positioned and depressed downwardly within the receptacle so as to cause the screw head to depress the nozzle button to spray paint upon the golf hole sidewall. The spray can is rotated to spray the golf hole's entire interior circumference.

Unfortunately, the apparatus described in U.S. Pat. No. 4,797,305 suffers from several deficiencies. First, spray can nozzle buttons are typically sloped so that when a spray can and corresponding nozzle button are depressed downwardly, the nozzle button has propensity to slide off the screw head causing the button to spray undesirably upwardly and downwardly thereby wasting paint and providing a non-uniform finish. An attempt has been made to overcome this deficiency by drilling an indentation into the top surface of the spray can's push button for receipt of the screw head. Though this approach is somewhat successful, it requires substantial work to modify existing spray cans.

An additional deficiency of the apparatus described in U.S. Pat. No. 4,797,305 is that any inadvertent vertical alignment of the spray can or extended spraying of the spray can in one place can cause paint to spray lower within the golf hole than desired. This non-uniform spraying can create an uneven pattern of paint within the golf hole and can even cause undesirable paint to spray onto the golf hole cup.

There is therefore significant need for an improved apparatus for providing a more uniform paint coating within a golf hole.

There is also a need for an improved apparatus which does not require the modification of the nozzle button of existing spray cans.

It would also be desirable for an apparatus which provides for an anesthetically pleasing uniform coating of paint unmarked by brush strokes or streaks within a golf hole.

### SUMMARY OF THE INVENTION

Briefly, in accordance with the invention, I provide an improved spray paint can holder for positioning a spray paint can during the painting of the interior of a golf hole. For purposes herein, the terms “spray paint can”, and simply “paint can” are used synonymously to refer to a traditional paint container having a pressurized substantially cylindrical body and a valve assembly at the cylindrical body's top surface. The valve assembly includes a depressible button causing the valve to open to discharge the paint from the container. The push button may include an upper sloped surface and includes a nozzle for producing a fan-like spray of paint.

The spray paint can holder of the present invention includes a base, preferably in the form of a cylindrical disk, which has a central circular opening defining a central axis. The spray paint can holder further includes a plurality of arms which project inwardly and downwardly to form a receptacle for holding an inverted spray can including its valve assembly. The spray paint can holder may include any number of arms. However, a preferred construction includes four arms spaced equal distance about the periphery of the base so as to provide sufficient structure for adequately holding the spray paint can while not providing too much structure which would undesirably block the spray of paint.

The spray paint can holder of the present invention further includes a plate engaging the inner ends of the arms. The arms position the plate parallel and below the paint can holder's base. In a preferred embodiment, the plate is substantially circular and has a diameter substantially the same as a golf hole. The plate is preferably positioned approximately 1″ below the base and is centrally aligned with the base's central axis to form an annular space between both the base and plate.

In a preferred embodiment, the spray paint can holder further includes a cup which is positioned on the plate's center. The cup includes a circular sidewall forming a central cavity which is sized to capture the nozzle button of a spray can. A projection in the form of a nub projects upwardly from the center of the cup for engaging a spray can nozzle when the spray can is placed in an inverted position within the receptacle. The apparatus may include a skirt which extends downwardly from the base opening to prevent paint from being applied to grass around the golf hole.

It is therefore an object of the present invention to provide an apparatus for painting the interior of a golf hole.

It is an additional object of the invention to provide an apparatus which provides a uniform coating and uniform masking for creating a golf hole wherein the paint has a uniform thickness within its interior edge.

It is still a further object of the invention to provide an improved apparatus for holding a golf can which does not require making any alterations to the push button nozzle of typical spray cans.

These and other objects and advantages of the invention will be apparent to those skilled in the art from the following detailed description taken in conjunction with the drawings.

### BRIEF DESCRIPTION OF THE DRAWINGS

FIG. 1 is a perspective view of the spray paint can holder of the present invention;

FIG. 2 is a perspective view illustrating the spray paint can holder of the present invention about to be introduced into a golf hole within which a cup has already been placed;

FIG. 3 is a side cutaway view illustrating the spray paint can holder of the present invention positioned within a golf hole wherein a spray can is being introduced into the apparatus' interior receptacle; and

FIG. 4 is a side cutaway view illustrating the spray paint can holder of the present invention within a golf hole holding a spray can wherein the can has been depressed downwardly to cause activation of the spray can's valve assembly to spray paint.

### DETAILED DESCRIPTION OF THE INVENTION

While the present invention is susceptible of embodiments in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

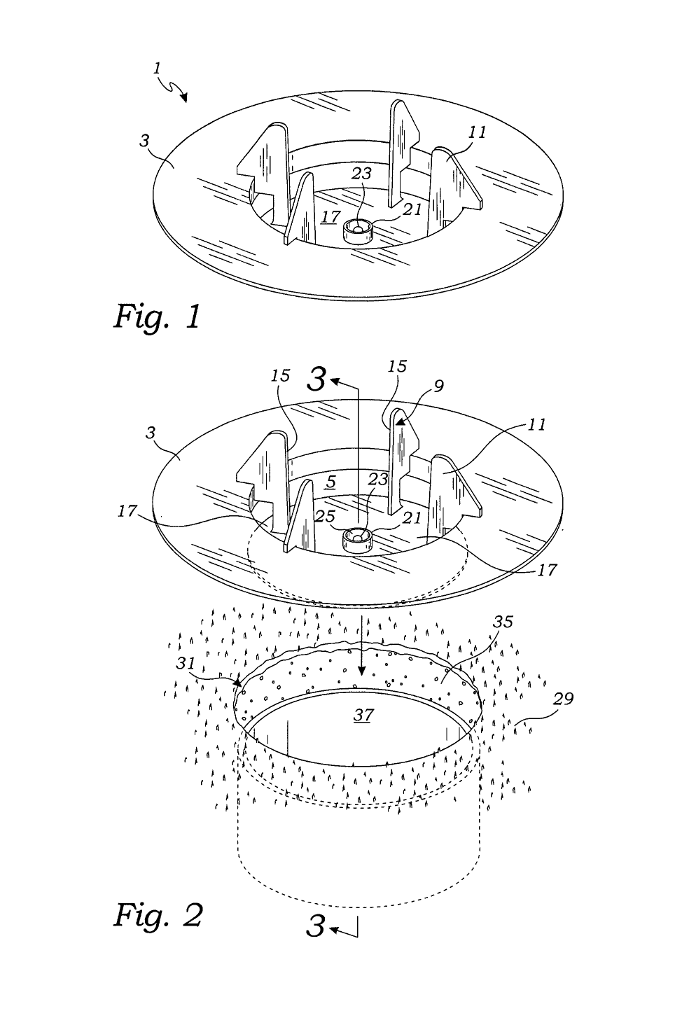

With reference to FIGS. 1-4, the apparatus 1 for positioning a spray paint can 41 is intended for use in providing a uniform strip of paint around the interior rim of a golf hole. As best seen in FIG. 2, a golf green 21 includes a circular golf hole 31 formed into the grassy surface 3 of a golf green. With the introduction of a cup 37 into the bottom interior of the golf hole, a dirt and grass periphery 35 is created which would desirably be painted white so as to be visually seen by golfers at a greater distance. The positioning apparatus 1 includes a substantially planar base 3 which may take various shapes, but as shown in the figures is preferably circular to provide a disk-like structure. The base 3 has a central opening 5 having a center defining a central axis 7. The central opening 5 preferably has a circular opening having a diameter slightly less than the diameter of a golf hole. The paint can positioning apparatus 1 may include a skirt 18 formed downwardly from the periphery of the opening 5. The skirt 18 prevents the inadvertent application of paint to the surface of the golf green.

The paint can positioning apparatus 1 further includes a receptacle structure 9 for holding a spray paint can. The receptacle includes a plurality of arms 11 which extend from the base 3 inwardly and downwardly for entering a golf hole. Preferably, the arms 11 are spaced equal distance around the periphery of the opening 5 and are sufficiently thin that they do not interfere with the painting of the hole. While any number of arms may be provided, it is preferred that the positioning apparatus of the invention have at least three and ideally four arms. Each of the arms 11 preferably include parallel vertically extending edge surfaces 15 which are spaced apart from one another at a distance sufficient to allow the introduction of a spray paint can 41.

The spray can positioning apparatus 1 further includes a plate 17 which engages the bottom ends of each of the arms 11. Though the plate may take various shapes and forms, in a preferred embodiment the plate 17 is substantially circular and has a diameter substantially the same as the golf hole so when introduced into a golf hole, the plate masks the bottom of the golf hole from paint emitted from the paint can.

In a preferred embodiment, preferably the paint can positioning apparatus 1 of the present invention further includes a cup 19 formed atop the center of the masking plate 17. The cup includes a circular sidewall 21 forming a cavity 25 sized for receipt of the push button 45 of a spray paint can 41. The diameter of the cup's cylindrical sidewall 21 is sized to restrict lateral movement of the spray can's push button, but not restrict rotation of the push button. Extending upwardly from the masking plate 17 at the cup's center is a projection 23. The projection 23 extends upwardly in the middle of the cup's central cavity 25 to form an annular space 27 for receipt of the sloped extremity of the spray can's push button.

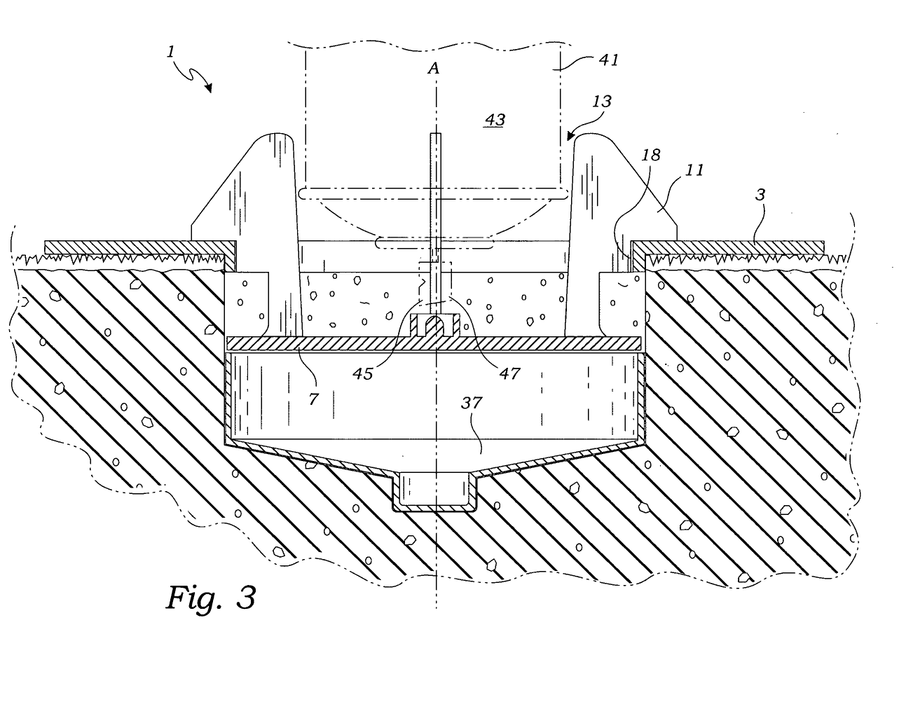

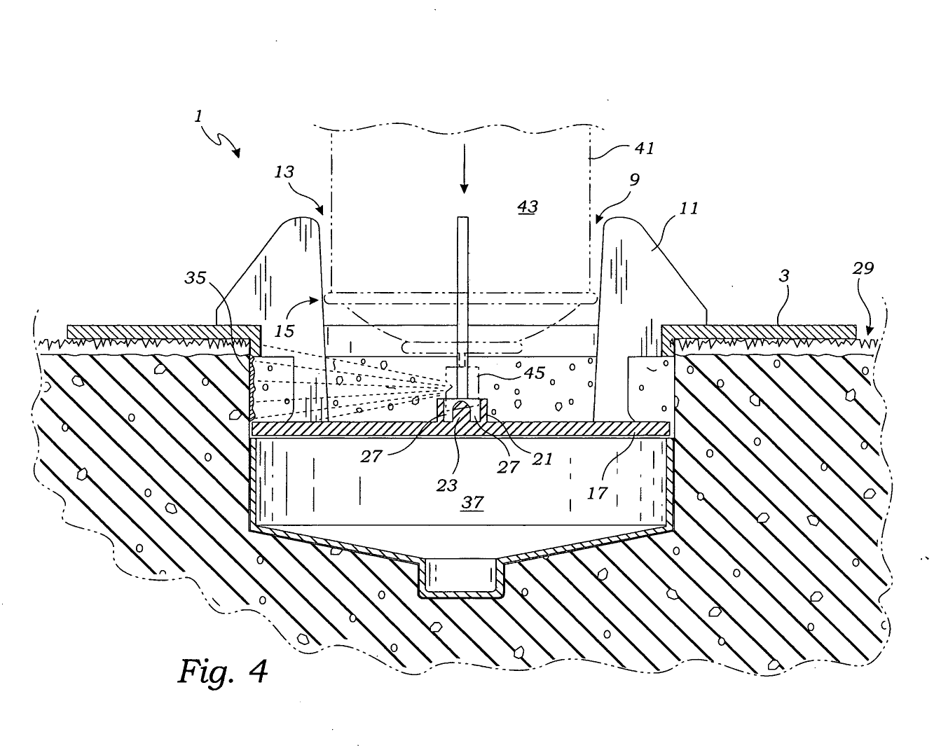

In operation, the paint can positioning apparatus may be used with any spray paint can 41 having a cylindrical housing 43, and a push button valve assembly 45. Advantageously, the positioning apparatus does not require modification of push buttons 45 having a sloped surface as seen in FIGS. 3 and 4.

Spray painting of the interior rim of a golf hole is accomplished by positioning the paint can positioning apparatus 1 within a golf hole so that the base 3 engages the grass of the golf green and the skirt 18 is brought into concentric contact with the top of the hole. The apparatus' receptacle 9 and corresponding arms 11 extend downwardly and inwardly into the golf hole for receipt of a spray can. A spray paint can is inverted and inserted into the receptacle so that the push button 45 engages projection 23 with the push button held in place by the cup's sidewall 21. The spray paint can 41 is depressed downwardly causing the push button 45 to be depressed against projection 23 thereby activating the valve assembly to initiate the flow of paint from the paint can's nozzle. The paint can 41 and push button 45 are manually rotated by a greenskeeper for at least one full rotation while the push button is depressed against projection 23 to apply the desired paint coating to the sidewall 32 of the golf hole 31.

Advantageously, the cup 19 and projection 23 combination provides for proper alignment and positioning of the spray can push button during the entire application of paint without requiring any modification of the push button. In addition, the circular shape of the plate 17 masks the bottom of the golf hole from unwanted spray from the spray can thereby providing a uniform strip of white paint around the interior periphery of the golf hole.

As would be understood by those skilled in the art, the present invention is relatively simple to use, inexpensive to manufacture, and economical in that less paint is used to obtain a more uniform coating. The positioning apparatus 1 may be made from various materials including metals and plastics. In a preferred embodiment, the positioning apparatus 1 is made of plastic in a molding operation.

While only a single embodiment of the invention has been illustrated and described, it will be apparent that various modifications can be made without departing from the spirit and scope of the invention. Therefore, it is intended that the invention embrace all alternatives, modifications and variations and only be limited by the following claims.

1. A spray paint can holder for positioning a spray paint can during the painting of the interior of a golf hole formed into a golf course green, the paint can holder comprising:
a base for resting upon a golf course green, said base have a central opening having a central axis to be aligned with the center of a golf hole;
a plurality of arms projecting inward and downward from said base so as to form a receptacle for centrally and vertically positioning an inverted spray paint can within a golf hole;
a masking plate engaging said arms so as to be positioned parallel and below said base so as to form an annular space between said base and said plate, said plate being substantially circular to form a disc and having a diameter sized to substantially fill said golf hole to prevent paint from a spray paint can within said receptacle from spraying below said masking plate;
a projection projecting upward from the center of said masking plate so as to engage the nozzle button of a spray paint can positioned within said receptacle.

2. A spray paint can holder for positioning a spray paint can during the painting of the interior of a golf hole formed into a golf course green, the paint can holder comprising:
a base for resting upon a golf course green, said base have a central opening having a central axis to be aligned with the center of a golf hole;
a plurality of arms projecting inward and downward from said base so as to form a receptacle for centrally and vertically positioning an inverted spray paint can within a golf hole;
a plate engaging said arms so as to be positioned parallel and below said base;
a cup engaging said plate, said cup including a circular sidewall concentrically aligned with said central axis forming a central cavity which is sized to capture the nozzle button of a spray can so as to prevent lateral movement of the nozzle when an inverted spray can is positioned within said receptacle; and
a projection projecting upward from the center of said cup so as to engage the nozzle button of a spray paint can positioned within said receptacle.

3. A spray paint can holder for positioning a spray paint can during the painting of the interior of a golf hole formed into a golf course green, the paint can holder comprising:
a base for resting upon a golf course green, said base have a central opening having a central axis to be aligned with the center of a golf hole;
a plurality of arms projecting inward and downward from said base so as to form a receptacle for centrally and vertically positioning an inverted spray paint can within a golf hole;
a masking plate engaging said arms so as to be positioned parallel and below said base so as to form an annular space between said base and said plate, said plate being substantially circular to form a disc and having a diameter sized to substantially fill said golf hole to prevent paint from a spray paint can within said receptacle from spraying below said masking plate;
a cup engaging said masking plate, said cup including a circular sidewall concentrically aligned with said central axis forming a central cavity which is sized to capture the nozzle button of a spray can so as to prevent lateral movement of the nozzle when an inverted spray can is positioned within said receptacle; and
a projection projecting upward from said masking plate through the center of said cup so as to engage the nozzle button of a spray paint can positioned within said receptacle.
